(19) United States
(12) Patent Application Publication
(10) Pub. No.: US 2012/0248296 A1
(43) Pub. Date: Oct. 4, 2012

(54) STAR SENSOR WITH REDUCED SENSITIVITY TO STRAY LIGHT INDUCED BY THE SUN OR BY OTHER SOURCES CLOSE TO THE FIELD OF VIEW

(76) Inventor: Fabrizio Giulianini, Roma (IT)

(21) Appl. No.: 12/594,426

(22) PCT Filed: Apr. 4, 2007
(86) PCT No.: PCT/IT2007/000257

§ 371 Date: Nov. 17, 2010

(51) Int. Cl. G01D 5/26; G01C 21/02

(52) U.S. Cl. 250/216

(57) ABSTRACT

The sensor comprises a detector (103) and a primary objective (105) arranged in front of the detector to form on said detector images of stars present in the field of view of the sensor. Between the objective (105) and the detector (103) is arranged a field stop (107) positioned substantially in the focal plane (P) of the objective (105). Between the field stop (107) and the detector (103) is arranged a relay optics (111) for conveying an image from the focal plane of the objective to the detector.

### TECHNICAL FIELD

The present invention relates to star sensors or so-called attitude sensors. These sensors are normally used in variable number on artificial satellites or other devices in general for space applications, for the purpose of controlling the attitude of the device or vehicle with respect to the celestial vault.

### STATE OF THE ART

In order to control and possibly modify the attitude of a space vehicle, such as a satellite or the like, set on the vehicle itself are one or more star sensors, which detect an image of a portion of the celestial vault in order then to make the comparison of the image detected with stored stellar maps so as to verify, control, and possibly modify the attitude of the device or vehicle on which the sensor or sensors are set.

Star sensors are constituted in general by an objective that forms on an array detector images of the stars present in the field of view of the objective itself. The recognition of the stars through stellar maps enables identification of the direction of the optical axis of the objective and the angle of orientation of the detector with respect to the celestial vault and hence in practice the attitude of the device or vehicle on which the sensor is installed.

Described in U.S. Pat. No. 4,944,587 is a system with a star sensor and a device for comparing the image acquired by the sensor with a stored stellar map.

In order to shield the stray light that comes from objects out of the field of view, which would perturb the image, reducing the capacity for distinguishing the stars until it is eliminated altogether, blinding the detector, there are currently used “lens hoods”, referred to as “baffles” or “shadows”. These elements are objects that have dimensions generally larger than those of the optics set downstream. The more efficient the baffles are and the smaller the angle of rejection of stray light that they provide, the larger their dimensions.

The dimensions of the baffles for shielding, for example, the light of the sun close to the field of view, for instance 10° from the field of view, become prohibitive.

By “angle of rejection of stray light” is meant the minimum angle that the sun (or other source of stray light) can subtend with the optical axis of the sensor, without jeopardizing operation thereof. Said angle of rejection must be greater than half of the angle of the field of view of the sensor.

Examples of star sensors equipped with baffles or shadows are described in JP-A-2003/226300 and JP-A-2002/131078.

In the specific field of interest of the present invention, there is increasingly felt the need to have available sensors that can work with very small angles of rejection of stray light, i.e., with sources of stray light (such as the sun and the like) that are external but very close to the edge of the field of view of the sensor. The reason for this is that, by reducing the minimum angle at which the source of disturbance can be located with respect to the optical axis of the system, it is possible to reduce the overall number of sensors to be positioned on a space vehicle or device, i.e., in other words, it is possible to make the sensor work in a greater number of possible positions of the sensor itself with respect to the sun or other disturbing sources of light.

### OBJECTS AND SUMMARY OF THE INVENTION

According to a particular aspect, the invention provides a star sensor or attitude sensor that enables more efficient blocking of the radiation emitted by the objects out of the field of view, reducing the minimum angle formed between the optical axis of the system and the source, the radiation of which is to be excluded from the field of view of the sensor.

Basically, according to one embodiment, the invention provides a star sensor comprising a detector and a primary objective arranged in front of the detector to form on the detector images of stars present in the field of view of the sensor itself, wherein between the primary objective and the detector a field stop is arranged, positioned substantially in the focal plane of the objective. Furthermore, between the field stop and the detector is arranged a relay optics for conveying the image from the focal plane of the objective to the detector.

Basically, contrary to what occurs in traditional attitude sensors or star sensors, according to one aspect of the invention the detector is not set directly in the focal plane of the objective but rather at a distance therefrom, and a field stop is positioned in the focal plane of the primary objective. This, in combination with the relay system for conveying the image, enables attenuation of the residual radiation diffused by the walls of the primary objective and by the absorbent-reflective stops set before the field stop that reaches the detector. These elements could otherwise illuminate by diffusion a detector set directly in the focal plane of the objective.

According to a preferred embodiment of the invention, set between the objective and the field stop is a pupil stop, preferably positioned substantially in the exit pupil of the primary objective or in a position corresponding to a real image thereof.

In one embodiment, the field stop comprises highly absorbent surfaces. In a preferred embodiment, said surfaces are absorbent-reflective. Alternatively, the surfaces are absorbent-diffusive. In one embodiment, at least the surface facing the objective is treated in order to be absorbent-reflective or absorbent-diffusive. Preferably, both of the surfaces are treated so as to be absorbent-reflective or absorbent-diffusive.

By “highly absorbent surface” is in general meant a surface treated optically in such, a way as to absorb a large quantity of the incident radiation, typically above 90%, and more preferably above 95%, and even more preferably in the region of 98-99% of the incident light. The characteristic of the absorbent-reflective treatment is such that the fraction of light that is not absorbed by the surface thus treated is reflected and not diffused; hence, the term “absorbent-reflective” referred to this type of treatment. By “absorbent-diffusive treatment” is meant, instead, a treatment in which the surface diffuses the fraction of non-absorbed radiation.

According to an embodiment of the invention, the pupil stop also comprises highly absorbent surfaces, preferably absorbent-reflective or alternatively absorbent-diffusive ones. In one embodiment, the surface of the pupil stop facing the detector is treated to be absorbent-reflective or absorbent-diffusive. It may also be convenient for the surface of the pupil stop facing outwards to be absorbent-reflective or absorbent-diffusive.

With a configuration according to the invention, it is possible to reach stray light-rejection angles larger by just a fraction of degree than the half-field of view. The source of stray light can thus even almost arrive at lapping the field of view of the sensor. Said result can be achieved even without the use of baffles or shadows and hence preventing the encumbrance, weight, and cost of said elements. The efficiency of the system in terms of stray light rejection can be slightly improved also using a baffle or shadow set in front of the objective; however said baffle can have dimensions substantially smaller than the ones used in traditional star sensors and which in any case cannot achieve the reduced values of the rejection angle that can be achieved with the optics of the star sensor of the present invention.

In a possible embodiment, the relay optics has an image magnification ratio for example comprised between 1.2 and 2, preferably between 1.4 and 1.6, and even more preferably approximately of around 1.5.

Further advantageous features and embodiments of the invention will be described in what follows with reference to an example of embodiment.

According to a further aspect, the invention concerns a star sensor comprising a detector and a primary objective arranged in front of the detector to form on said detector images of stars present in the field of view of the sensor, wherein between the primary objective and the detector is arranged a field stop, positioned substantially in the focal plane of the primary objective, and wherein between the field stop and the primary objective is a further stop, preferably positioned substantially in the exit pupil of the primary objective or in a real image thereof.

### BRIEF DESCRIPTION OF THE DRAWINGS

A better understanding of the invention will be obtained from the ensuing description and the annexed drawings, which show a practical embodiment of the invention. More in particular, in the drawings:

FIG. 1A is a diagram of an usual star sensor or attitude sensor provided with external baffles;

FIG. 1B is a diagram of a traditional baffle, for a better understanding of its operation; and

FIG. 2 is a diagram of a sensor according to the invention.

### DETAILED DESCRIPTION OF EMBODIMENTS OF THE INVENTION

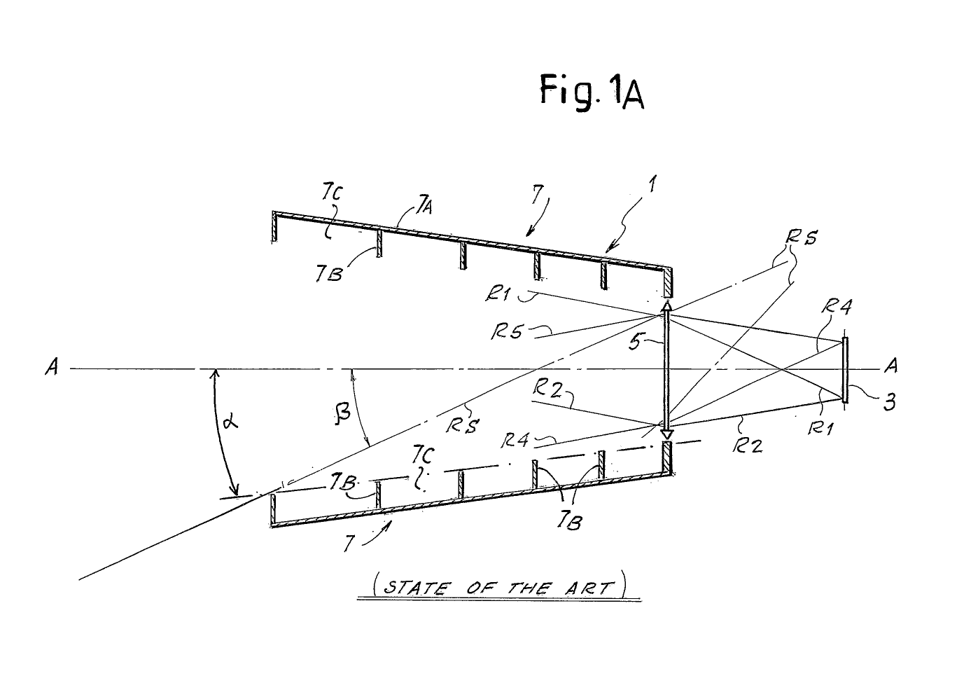

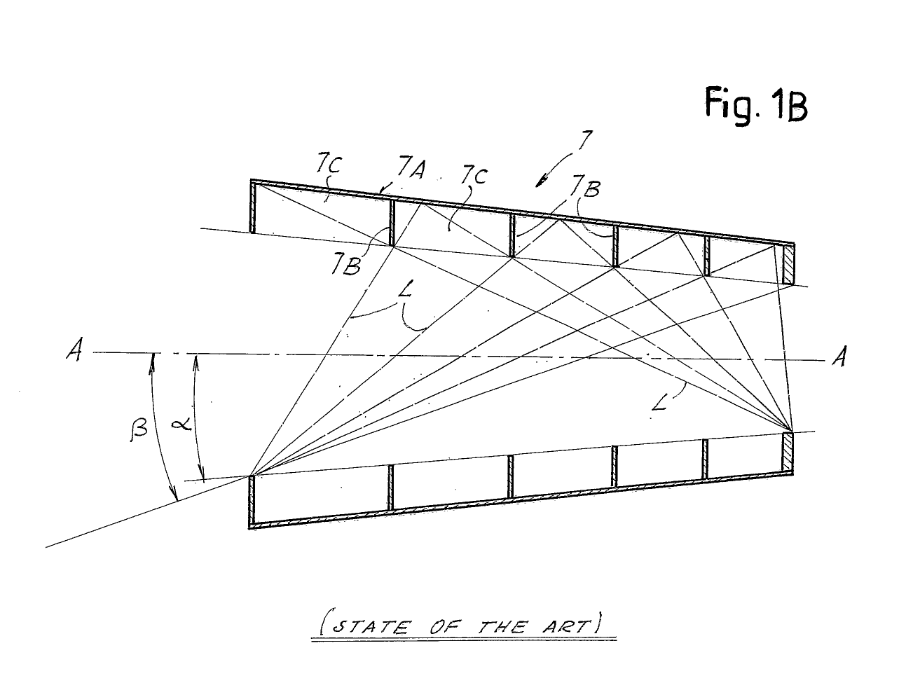

For a better understanding of the present invention, an optical system of a traditional sensor shown schematically in FIG. 1A will first be briefly described. The sensor, designated as a whole by 1, comprises an array detector 3, on which the image of a portion of the celestial vault is formed by means of a primary objective, constituted by a more or less complex optics, designated schematically herein by 5.

Set in front of the primary objective 5 is an external baffle or shadow 7, which has a particularly large length with respect to the dimension of the objective 5 and the detector 3. The function of the baffles 7 is to shield the objective 5 of the sensor 1, preventing the radiation of sources external to the field of view, for example light radiation coming from the sun, which would blind the detector 3 and thus jeopardize proper operation thereof, from reaching the detector 3 along the optical path.

Designated by A-A in the diagram of FIG. 1A is the optical axis of the system, and designated by a is the half-angle of the useful field of view of the sensor. In order to be able to work with angles α as close as possible to the edge of the field of view, it is necessary to increase the longitudinal dimension of the baffle 7 in order to prevent the radiation coming from sources out of the field of view from reaching the objective 5 and thence the detector 3.

Designated by R₁, R₂, and R₄ are rays useful for the formation of the image, which, traversing the objective 5, reach the detector 3. Designated by R_{S} are the rays of stray light coming from a spurious source, shielded by the baffle 7.

The baffle 7 is formed by a conical wall 7A, set inside which are annular stops 7B that have the function of blocking the stray light. Defined between adjacent stops 7B are gaps 7C. The criterion of sizing of a baffle of this type can be understood with reference to the diagram of FIG. 1B. Designated by a is the angle subtended by the field of view of the device. Designated by β is the stray light rejection angle, and designated by L are geometrical lines that have the purpose of determining, via a geometrical construction procedure, the number and position of the annular stops 7B. The procedure of geometrical construction shown in FIG. 1B is based upon a criterion of average severity. The more severe the criterion of sizing, the greater the number of gaps 7C and hence of annular stops 7B that it is necessary to have available within the baffle 7. This considerably increases the weight of the device and its cost. A reduction of the angle β, on the other hand, entails an increase in the length of the baffle and hence also in the number of annular stops 7B and in the overall encumbrance of the device.

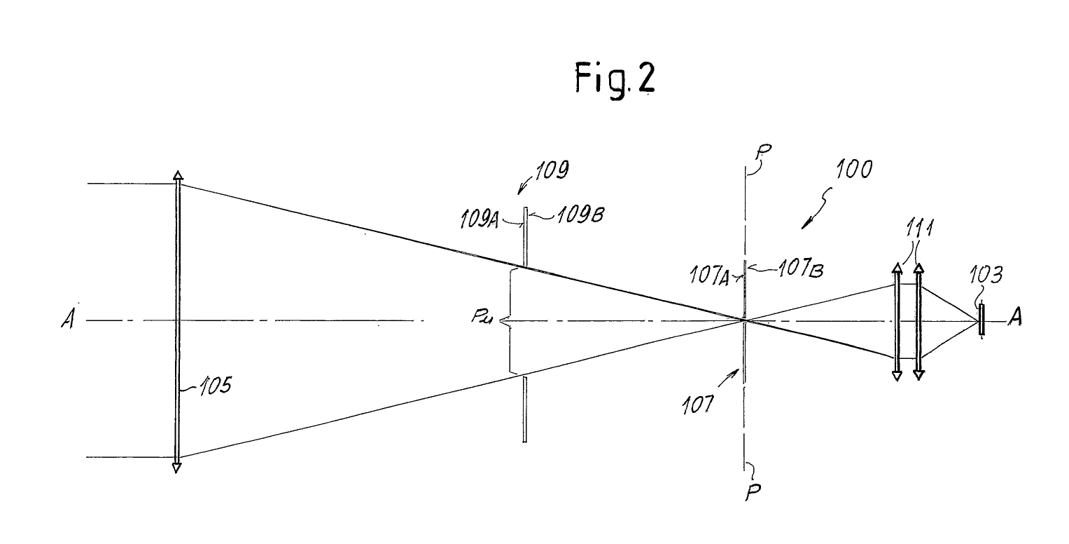

In order to achieve angles 13 substantially smaller than the ones that can currently be achieved with acceptable dimensions of the baffles 7, according to an embodiment of the present invention an optical scheme of the type illustrated in FIG. 2 is provided. The optical sensor is herein designated as a whole by 100, and the detector is designated by 103. Located in front of the detector 103 is an objective, designated as a whole by 105. This objective, also referred to as “primary objective”, can have a configuration of any type compatible with the functions that the sensor 100 must perform. More in particular, the objective 105 can be a dioptric, catoptric or catadioptric objective.

Along the optical axis A-A of the sensor 100, between the primary objective 105 and the detector 103 is arranged a field stop 107 that is located substantially in the plane of the image, schematically designated by P, of the primary objective 105. In the diagram illustrated, set between the primary objective 105 and the field stop 107 is a pupil stop 109, positioned substantially in the exit pupil Pu of the primary objective 105, or in a position corresponding to a real image thereof.

For conveying the image from the plane P-P to the detector 103, between the field stop 107 and the detector 103 is arranged a relay optics, schematically designated by 111. This relay optics or system can have an image reduction ratio of 1:1.5.

Obtained with the optics of FIG. 2 are stray light rejection angles β which are very close to the angle of half-aperture of the field of view of the sensor even without the use of external baffles. In one embodiment of the invention, it is possible to provide, in addition to the elements indicated as a whole in FIG. 2, also an external baffle or shadow in front of the primary objective 105.

The internal and external surfaces 109A, 109B of the pupil stop 109, as well as the external surface 107A and preferably the internal surface 107B of the field stop 107, are treated with an absorbent-reflective or absorbent-diffusive treatment, so as to absorb a quantity of incident radiation equal to or greater than 90% and preferably equal to or greater than 95%, and even more preferably equal to or greater than 98%, and to reflect or diffuse the portion of radiation that is not absorbed. Preferably the surface treatment is such as to obtain absorbent-reflective surfaces, instead of absorbent-diffusive surfaces. With these degrees of absorption, the diffusion of spurious radiation through the optics that come from the area out of the field of view and that could reach the detector 103 is limited.

The relay system or relay optics 111 drastically reduces the residual radiation that can reach the detector and that is diffused by the edges of the pupil stop 109, by the walls of the primary objective, and by the absorbent-reflective stops set upstream of the field stop and not illustrated in the diagram of FIG. 2.

It is understood that the drawings merely show one example, provided purely as a practical illustration of the invention, it being possible for said invention to vary in the embodiments and arrangements, without thereby departing from the scope of the idea underlying the invention itself.

1. A star sensor comprising:
a detector and a primary objective arranged in front of the detector to form on said detector images of stars present in the field of view of the sensor, wherein between said objective and said detector is a field stop positioned substantially in the focal plane of the objective, wherein between said field stop and said detector is a relay optics for conveying an image from the focal plane of the objective to said detector.

2. A sensor according to claim 1, wherein between the objective and the field stop is arranged a pupil stop positioned substantially in the exit pupil of the objective.

3. A sensor according to claim 1, wherein between the objective and the field stop is arranged a pupil stop positioned substantially in a point corresponding to a real image of the exit pupil of the objective.

4. A sensor according to claim 1, wherein said field stop comprises at least one highly absorbent surface.

5. A sensor according to claim 4, wherein said field stop comprises a highly absorbent surface facing the objective and preferably a highly absorbent surface facing said detector.

6. A sensor according to claim 4, wherein said surface is absorbent-reflective.

7. A sensor according to claim 4, wherein said surface is absorbent-diffusive.

8. A sensor according to claim 2, wherein said pupil stop comprises at least one highly absorbent surface.

9. A sensor according to claim 8, wherein said pupil stop comprises a highly absorbent surface facing said field stop and preferably a highly absorbent surface facing said objective.

10. A sensor according to claim 8, wherein said highly absorbent surface or surfaces of the pupil stop is/are absorbent-reflective.

11. A sensor according to claim 8, wherein said highly absorbent surface or surfaces of the pupil stop is/are absorbent-diffusive.

12. A sensor according to claim 4, wherein said highly absorbent surface or surfaces of the field stop and/or of the pupil stop absorbs/absorb more than 90% of the incident radiation, and preferably at least 95%, and more preferably at least 98%, of the incident radiation, the radiation not absorbed being reflected.

13. A sensor according to claim 1, wherein said relay optics has an image magnification ratio.

14. A star sensor comprising:
a detector and an objective set in front of the detector to form on said detector images of stars present in the field of view of the sensor, wherein between said objective and said detector is arranged a field stop positioned substantially in the focal plane of the objective, wherein between said field stop and said objective is arranged a further stop.

15. A sensor according to claim 14, wherein said further stop is set substantially in the exit pupil of the objective or in a real image thereof.

16. A sensor according to claim 14, wherein said field stop and said further stop comprise surfaces facing one another presenting highly absorbent characteristics.

17. A sensor according to claim 16, wherein said further stop has a surface facing the objective presenting highly absorbent characteristics.

18. A system for controlling the attitude of a space vehicle comprising:
one or more star sensors comprising a detector and a primary objective arranged in front of the detector to form on said detector images of stars present in the field of view of the one or more sensors, wherein between said objective and said detector is a field stop positioned substantially in the focal plane of the objective, wherein between said field stop and said detector is a relay optics for conveying an image from the focal plane of the objective to said detector.
